(19) United States
(12) Patent Application Publication
(10) Pub. No.: US 2017/0006872 A1
(43) Pub. Date: Jan. 12, 2017

(54) METHOD FOR CONTROLLING PESTS

(71) Applicant: SUMITOMO CHEMICAL COMPANY, LIMITED, Tokyo (JP)

(72) Inventor: Emiko SAKAMOTO, Hyogo (JP)

(21) Appl. No.: 15/114,223

(22) PCT Filed: Jan. 21, 2015
(86) PCT No.: PCT/JP2015/052248

§ 371 Date: Jul. 26, 2016

(30) Foreign Application Priority Data
Jan. 28, 2014 (JP) 2014-013042

(51) Int. Cl. A01N 57/12; A01N 47/40; A01N 43/56; A01N 43/78; A01N 43/88; A01N 43/50; A01N 25/12; A01N 47/12

(52) U.S. Cl. CPC A01N 57/12; A01N 25/12; A01N 47/40; A01N 47/12; A01N 43/78; A01N 43/88; A01N 43/50; A01N 43/56

(57) ABSTRACT

A method for controlling pests by incorporating into the soil effective amounts of one or more compounds selected from the following compound group (A) and one or more compounds selected from the following compound group (B) is provided. Compound group (A) includes clothianidin, thiamethoxam, imidacloprid, and fipronil, and compound group (B) includes cadusafos, oxamyl, and fluensulfone.

### TECHNICAL FIELD

The present invention relates to a method for controlling pests.

### BACKGROUND ART

Various compounds having a control effect on pests which cause damage to crop, such as arthropods including insects and nematodes, are known (for example, refer to EP 0580553 A, EP 0295117 A, WO 2001/002378 A, The Pesticide Manual-16th edition (published by BCPC); ISBN 978-1-901396-86-7, Compendium of Pesticide Common Names, [online], Dec. 10, 1996, [searched on Dec. 6, 2013], internet <URL:http://www.alanwood.net/pesticides/>). However, in the method for controlling pests using these compounds, there has been a case that a sufficient effect is not obtained.

### DISCLOSURE OF THE INVENTION

An object of the present invention is to provide a method for controlling pests exhibiting an excellent control effect on pests.

As a result of studying to solve the above problem, the present inventors have found that effective amounts of one or more kinds of compounds selected from the following compound group (A) and one or more kinds of compounds selected from the following compound group (B) are incorporated into the soil, thereby improving a control effect on pests.

More specifically, the present invention is as described in [1] to [6] below.

[1] A method for controlling pests comprising a step of incorporating into the soil effective amounts of one or more kinds of compounds selected from the following compound group (A) and one or more kinds of compounds selected from the following compound group (B).
Compound group (A): group consisting of clothianidin, thiamethoxam, imidacloprid, and fipronil.
Compound group (B): group consisting of cadusafos, oxamyl, and fluensulfone.
[2] The method for controlling pests according to [1], wherein the weight ratio of the one or more kinds of compounds selected from the compound group (A) to the one or more kinds of compounds selected from the compound group (B) is in the range of 20:1 to 1:200.
[3] The method for controlling pests according to [1] or [2], wherein the step is a step of incorporating into the soil a granule containing effective amounts of one or more kinds of compounds selected from the compound group (A) and one or more kinds of compounds selected from the compound group (B).
[4] The method for controlling pests according to any one of [1] to [3], comprising steps of incorporating into the soil effective amounts of one or more kinds of compounds selected from the compound group (A) and one or more kinds of compounds selected from the compound group (B), and planting a crop in the incorporated soil.
[5] The method for controlling pests according to [4], wherein the step of planting a crop is carried out, within 20 days from immediately after incorporating into the soil effective amounts of one or more kinds of compounds selected from the compound group (A) and one or more kinds of compounds selected from the compound group (B).
[6] The method for controlling pests according to [4] or [5], wherein the crop is sweet potato.

### MODE FOR CARRYING OUT THE INVENTION

The one or more kinds of compounds selected from the compound group (A) (hereinafter, referred to as the present compound A) and the one or more kinds of compounds selected from the compound group (B) (hereinafter, referred to as the present compound B) used in the present invention will be described. Clothianidin, thiamethoxam, imidacloprid, fipronil, cadusafos and oxamyl are all known compounds, and described, for example, in 225, 1104, 640, 491, 148 and 838 of “The Pesticide Manual—16th edition (published by BCPC); ISBN 978-1-901396-86-7”. These compounds can be obtained from a commercially available formulation or produced by a known method.

In addition, fluensulfone is also a known compound, and described, for example, at page 513 of “The Pesticide Manual-16th edition (published by BCPC); ISBN 978-1-901396-86-7”, and can be produced by a method described in WO 2001/002378, and the like.

In the present invention, the use of fluensulfone as the present compound B is preferred, and an embodiment of using one or more kinds of compounds selected from clothianidin, thiamethoxam, imidacloprid and fipronil and fluensulfone in combination is preferable.

The present compound A and the present compound B used in the present invention may be the compound itself, respectively, but are normally used by mixing the present compound A, the present compound B, or both of them, and an inert carrier, and adding a surfactant or other auxiliaries for formulation as necessary, to be formulated into an oil solution, an emulsifiable concentrates, a flowable, a wettable powder, a wettable dispersible granule, a dust, a granule, or the like.

The content of the present compound A in the formulation containing the present compound A (hereinafter, referred to as the present formulation A) and the content of the present compound B in the formulation containing the present compound B (hereinafter, referred to as the present formulation B) are in the range of normally 0.05 to 99% by weight, preferably 0.08 to 90% by weight, and further preferably 0.1 to 70% by weight, respectively. Also, the total content of the present compound A and the present compound B in the formulation containing the present compound A and the present compound B (hereinafter, referred to as the present formulation C) is in the range of normally 0.05 to 99% by weight, preferably 0.08 to 90% by weight, and further preferably 0.1 to 70% by weight. The present formulation C may be a mixture of the present formulation A and the present formulation B.

The inert carrier used upon formulation includes solid carriers and liquid carriers. Examples of the solid carrier include fine powders or granules of minerals such as kaolin clay, attapulgite clay, bentonite, montmorillonite, acid white clay, pyrophyllite, talc, diatomaceous earth and calcite, natural organic materials such as corn cob powder and walnut husk powder, synthetic organic materials such as urea, salts such as calcium carbonate and ammonium sulfate, and synthetic inorganic materials such as synthetic hydrated silicon oxide. Examples of the liquid carrier include aromatic hydrocarbons such as xylene, alkylbenzene and methylnaphthalene, alcohols such as 2-propanol, ethylene glycol, propylene glycol and ethylene glycol monoethyl ether, ketones such as acetone, cyclohexanone and isophorone, vegetable oils such as soybean oil and cotton seed oil, and petroleum based aliphatic hydrocarbons, esters, dimethylsulfoxide, acetonitrile, and water.

Examples of the surfactant include anionic surfactants such as alkyl sulfonate ester salts, alkylaryl sulfonate salts, dialkyl sulfosuccinate salts, polyoxyethylene alkyl aryl ether phosphate ester salts, lignosulfonate salts and naphthalene sulfonate formaldehyde polycondensates, nonionic surfactants such as polyoxyethylene alkyl aryl ethers, polyoxyethylene alkylpolyoxypropylene block copolymers and sorbitan fatty acid esters, and cationic surfactants such as alkyltrimethylammonium salts.

Examples of the other auxiliaries for formulation include water-soluble polymers such as polyvinyl alcohol and polyvinyl pyrrolidone, arabic gum, alginic acid and salts thereof, polysaccharides such as CMC (carboxymethyl cellulose) and xanthan gum, inorganic substances such as aluminum magnesium silicate and alumina sol, preservatives, colorants, and stabilizers such as PAP (isopropyl acid phosphate) and BHT (2,6-di-tert-butyl-4-methylphenol).

The present invention relates to a method for controlling pests by treating the soil for cultivating crops with the effective amounts of the present compound A and the present compound B, wherein the treatment form is soil incorporation. Examples of the soil incorporation include pricking-in hole treatment (soil incorporation), planting furrow treatment (soil incorporation), planting row treatment (soil incorporation), broadcast treatment (soil incorporation), and the like. Herein, the pricking-in hole treatment (soil incorporation) (also refers to pricking-in hole (soil incorporation).) refers to a embodiment of putting the effective amounts of the present compound A and the present compound B in a hole (planting hole) made on the soil for planting the crops, and incorporating with the soil at the bottom of the planting hole. The planting furrow treatment (soil incorporation) (also refers to planting furrow (soil incorporation).) refers to a embodiment of putting the effective amounts of the present compound A and the present compound B in a furrow (planting furrow) made on the soil for planting the crops, and incorporating with the soil at the bottom of the planting furrow. The planting row treatment (soil incorporation) (also refers to planting row (soil incorporation).) refers to a embodiment of putting the effective amounts of the present compound A and the present compound B in a row on the surface of the soil for planting the crops, and incorporating the present compound A and the present compound B with the surface soil. The broadcast treatment (soil incorporation) (also refers to broadcast (soil incorporation).) refers to a embodiment of putting the effective amounts of the present compound A and the present compound B on the broadcast surface of the soil for cultivating crops, and incorporating with the surface soil. In the present invention, the surface soil is a soil layer in the uppermost part of the soil for cultivating crops and means a soil layer dug up for cultivating crops.

Also, in the present invention, an embodiment of incorporating the effective amounts of the present compound A and the present compound B into the soil at the same time is preferable.

In the present invention, the treatment amount of the present compound A and the present compound B may vary depending on the kind of crop, the kind and degree of generation of pests to be controlled, formulation form, treatment period, weather conditions, and the like, and the total amount of the present compound A and the present compound B is normally 0.1 to 5000 g, preferably 1 to 2000 g, and further preferably 10 to 1500 g, per 1000 m² of the land for cultivating crops.

Also, it is treated so that the weight ratio of the present compound A to the present compound B is in the range of normally 20:1 to 1:200, preferably 10:1 to 1:100, and further preferably 2:1 to 1:30.

When the present formulation A and the present formulation B or the present formulation C are used as the present compound A and the present compound B, and the formulation form is a granule, dust or the like, it is normally treated as it is without dilution. In the present invention, a granule is preferably used. In the case of an emulsifiable concentrate, a wettable powder, a wettable dispersible granule, a flowable or the like, the preparation may be treated as it is, but normally diluted with water for treatment. In this case, the total concentration of the present compound A and the present compound B in the water-diluted liquid is in the range of normally 0.00001 to 10% by weight, and preferably 0.0001 to 5% by weight.

The effective amounts of the present compound A and the present compound B may be incorporated into the soil where a crop is cultivated, and the effective amounts of the present compound A and the present compound B may be incorporated into the soil and a crop may be planted in the incorporated soil.

In particular, a crop is planted and cultivated after incorporating the effective amounts of the present compound A and the present compound B into the soil, whereby pests which cause damage to the crop can be controlled. Examples of the crop include the following crops.

Crops: corn, rice, cotton, soybean (including green soybean), peanut, sugar beet, rapeseed, sunflower, sugar cane, tobacco, etc.

Vegetables: Solanaceae vegetables (eggplant, tomato, green pepper, potato, hot pepper, etc.), Cucurbitaceae vegetables (cucumber, pumpkin, watermelon, melon, oriental melon, bitter gourd, wax gourd, oriental pickling melon, zucchini, etc.), Cruciferae vegetables (horseradish, kohlrabi, Chinese cabbage, cabbage, brown mustard, broccoli, cauliflower, rapeseed, etc.), Compositae vegetables (garland chrysanthemum, lettuce, etc.), Liliaceae vegetables (Welsh onion, Chinese chive, onion, garlic, Allium chinense, scallion, asparagus, etc.), Umbelliferae vegetables (carrot, parsley, celery, parsnip, etc.), Chenopodiaceae vegetables (spinach, Swiss chard, etc.), Labiatae vegetables (Japanese mint, mint, basil, etc.), strawberry, sweet potato, yam, Chinese yam, aroid, konjac, yam, lotus, ginger, etc.

Fruit trees: pomaceous fruits (apple, common pear, Japanese pear, Chinese quince, quince, etc.), stone fleshy fruits (peach, plum, nectarine, Japanese plum, cherry, apricot, prune, etc.), citrus plants (Satsuma mandarin, orange, lemon, lime, grapefruits, etc.), nuts (chestnut, walnut, hazel nut, almond, pistachio, cashew nut, macadamia nut, etc.), berry fruits (blueberry, cranberry, blackberry, raspberry, etc.), grape, persimmon, olive, loquat, banana, coffee, date, coconut, oil palm, etc.

Trees other than fruit trees: tea, mulberry, flowering trees and shrubs (tsutsuji azalea, peony, satsuki azalea, camellia, hydrangea, sasanqua, Illicium religiosum, cherry tree, tulip tree, crape myrtle, fragrant olive, etc.), street trees (ash tree, birch, dogwood, eucalyptus, ginkgo, lilac, maple tree, oak, poplar, cercis, Chinese sweet gum, plane tree, zelkova, Japanese arborvitae, fir tree, Japanese hemlock, needle juniper, pine, spruce, yew, elm, horse-chestnut, etc.), sweet viburnum, Podocarpus macrophyllus, Japanese cedar, Japanese cypress, croton, spindle tree, Chinese hawthorn, etc.

Flowers; tulip, lily, iris, petunia, chrysanthemum, lisianthus, gerbera, carnation, etc.

Among the above crops, potato, sweet potato, aroid, yam, cucumber, melon, pumpkin, watermelon, tomato, eggplant, green pepper, strawberry, cabbage, Welsh onion, Chinese chive and green soybean are preferred.

Also, the above crop may be a crop provided with herbicide resistance, resistance to pests or resistance to environmental stress by gene recombination technology and a classical breeding method.

The present invention is particularly preferable as a method for controlling pests in the case of planting and cultivating vegetative organ or nursery plant of crops. The vegetative organ herein refers to shoot, root, or a part thereof, and in the present invention, leaf and stem are collectively called as shoot. The vegetative organ specifically includes tuberous root, bulb, corm or solid bulb, tuber, rhizome, stolon, rhizophore, propagule, and vine cutting. Stolon is sometimes called as runner, and propagule is sometimes called as broad bud or bulbil. Also, vine cutting is a shoot of sweet potato, yam or the like. In the present invention, seedling and sapling are collectively called as nursery plant. Also, the foliar age of nursery plant is in the range of normally 1 to 15 true-leaf stage, preferably 1 to 5 true-leaf stage, and further preferably 1.5 to 3 true-leaf stage.

Also, in the present invention, an embodiment of planting a cucumber nursery plant, a cabbage nursery plant, a potato tuber or a sweet potato vine cutting is preferable.

The planting of crops is preferably performed from immediately after treatment of the effective amounts of the present compound A and the present compound B to 20 days after treatment, and further preferably performed from immediately after treatment to 10 days after treatment.

In the present invention, the effective amounts of the present compound A and the present compound B are incorporated into the soil, then the surface of the soil is covered with a covering material, whereby pests can be more effectively controlled. As the covering material, a plastic film is preferably used. The covering material is sometimes called as mulch, mulching film, and the like, and specific examples include white, black, green or transparent polyethylene mulching films, two-layered polyethylene mulching films with silver front side and black back side, white front side and black back side or the like, biodegradable mulching film made from fatty acid ester, polyvinyl alcohol, polybutyl succinate, polymer starch, pulp or the like. In the present invention, black polyethylene mulching film is preferably used. The timing of starting covering with the covering material is preferably from immediately after treatment of the effective amounts of the present compound A and the present compound B to 20 days after treatment, further preferably from immediately after treatment to 10 days after treatment, and further more preferably immediately after treatment.

In the present invention, one or more other pesticides also can be used in combination. Examples of other pesticides include insecticides, nematicides, fungicides, herbicides, plant growth regulators, and safener. Other pesticides may be treated simultaneously with the effective amounts of the present compound A and the present compound B, and may be treated separately.

According to the present invention, pests (insects and nematodes) can be controlled. Specifically, examples of the pests include the following pests.

Hemiptera pests: Delphacidae such as Laodelphax striatellus, Deltocephalidae such as Empoasca onukii, Aphididae such as Aphis gossypii, Myzus persicae, Brevicoryne brassicae, Aphis spiraecola, Macrosiphum euphorbiae, Aulacorthum solani, Rhopalosiphum padi, Toxoptera citricidus, Hyalopterus pruni, Acyrthosiphon pisum, Rhopalosiphum nymphaeae, Aphis naturtii, and Aphis fabae, Pentatomidae such as Halyomorpha mista and Lygus lineolaris, Aleyrodidae such as Trialeurodes vaporariorum, Bemisia tabaci, Bemisia argentifolii, Dialeurodes citri, and Aleurocanthus spiniferus, Coccidae such as Aonidiella aurantii and Comstockaspis perniciosa.

Lepidoptera pests: Pyralidae such as Ostrinia furnacalis, Hellula undalis, Pediasia teterrellus, and Ostrinia nubilaris, Noctuidae such as Spodoptera litura and Agrotis ipsilon, Pieridae such as Pieris rapae, Tortricidae such as Cydia pomonella, Yponomeutidae such as Plutella xylostella, and Gelechiidae such as Phthorimaea operculella.

Thysanoptera pests: Thripidae such as Frankliniella occidentalis, Thrips parmi, Scirtothrips dorsalis, Thrips tabaci, Frankliniella intonsa, and Frankliniella fusca.

Diptera pests: Anthomyiidae such as Delia platura and Delia antiqua, and Agromyzidae such as Liriomyza sativae, Liriomyza trifolii, and Chromatomyia horticola.

Coleoptera pests: corn rootworms (Diabrotica spp.) such as Diabrotica virgifera virgifera and Diabrotica undecimpunctata howardi, Scarabaeidae such as Anomala cuprea, Anomala albopilosa, Anomala rufocuprea, and Popillia japonica, Curculionidae such as Sphenophorus uniformis, Chrysomelidae such as Aulacophora femoralis and Leptinotarsa decemlineata, and Agriotes spp.

Nematoda: nematodes of the genus Meloidogyne such as Meloidogyne incognita, Meloidogyne javanica, Meloidogyne hapla, Meloidogyne arenaria, and Meloidogyne microcephala, nematodes of the genus Ditylelenchus such as Ditylelenchus destructor and Ditylelenchus dipsaci, nematodes of the genus Pratylenchus such as Pratylenchus cffeae, Pratylenchus penetrans, Pratylenchus vulnus, Pratylenchus neglectus, and Pratylenchus loosi, nematodes of the genus Globodera such as Globodera rostochiensis and Globodera pallida, nematodes of the genus Heterodera such as Heterodera glycines and Heterodera shachtoii, nematodes of the genus Aphelenchoides such as Aphelenchoides ritzemabosi, nematodes of the genus Radopholus such as Radopholus similis and Radopholus citrophilus, nematodes of the genus Tylenchulus such as Tylenchulus semipenetrans, nematodes of the genus Rotylenchulus such as Rotylenchulus reniformis, nematodes of the genus Ditylenchus such as Nothotylenchus acris, nematodes of the genus Nacobbus such as Nacobbus aberrans, nematodes of the genus Hemicriconemoides such as Hemicriconemoides kanayaensis, and the like.

The present invention is preferable as a method for controlling Aphididae, Aleyrodidae, Pyralidae, Noctuidae, Yponomeutidae, Thripidae, Agromyzidae, Scarabaeidae and Agriotes spp. as insects, and Meloidogyne incognita, Meloidogyne hapla, Meloidogyne arenaria, Pratylenchus cffeae, Pratylenchus penetrans and Globodera rostochiensis as nematodes, and particularly preferable as a method for controlling Aphididae, Pyralidae, Noctuidae, Yponomeutidae, Scarabaeidae and Meloidogyne incognita.

### EXAMPLES

Hereinbelow, the present invention will be further described in detail by formulation examples and test examples. However, the present invention is not limited to the following examples. In the following examples, the part means part by weight unless otherwise specifically noted.

First, formulation examples will be shown.

### Formulation Example 1

### Granule

One hundred parts of a mixture of 0.5 parts of clothianidin, 3 parts of cadusafos, 1 part of synthetic hydrous silicon oxide, 2 parts of calcium lignosulfonate, 30 parts of bentonite and the balance kaolin clay were well pulverized and mixed, water was added, and the mixture was well kneaded, then granulated and dried to obtain a granule.

### Formulation Example 2

### Granule

One hundred parts of a mixture of 0.5 parts of clothianidin, 0.8 parts of oxamyl, 1 part of synthetic hydrous silicon oxide, 2 parts of calcium lignosulfonate, 30 parts of bentonite and the balance kaolin clay were well pulverized and mixed, and water was added, and the mixture was well kneaded, then granulated and dried to obtain a granule.

### Formulation Example 3

### Granule

One hundred parts of a mixture of 0.5 parts of clothianidin, 2 parts of fluensulfone, 1 part of synthetic hydrous silicon oxide, 2 parts of calcium lignosulfonate, 30 parts of bentonite and the balance kaolin clay were well pulverized and mixed, water was added, and the mixture was well kneaded, then granulated and dried to obtain a granule.

### Formulation Examples 4 to 7

### Granule

The same procedures are carried out as in Formulation Examples 1 to 3, except for applying each compound and use amount listed in the following Table 1, in place of 0.5 parts of clothianidin, to obtain each of granules.

TABLE 1

| Formulation | | Use amount |
|---|---|---|
| Example | Compound | [parts] |
| 4 | Thiamethoxam | 0.5 |
| 5 | Imidacloprid | 1.0 |
| 6 | Fipronil | 0.5 |
| 7 | Fipronil | 1.0 |

### Formulation Example 8

### Wettable Powder

Fifteen parts of clothianidin and 15 parts of cadusafos are added to a mixture of 4 parts of sodium lauryl sulfate, 2 parts of calcium lignosulfonate, 20 parts of synthetic hydrous silicon oxide fine powder and the balance diatomaceous earth, and the mixture is well mixed by stirring to obtain 100 parts of wettable powder.

### Formulation Example 9

### Wettable Powder

Fifteen parts of clothianidin and 15 parts of oxamyl are added to a mixture of 4 parts of sodium lauryl sulfate, 2 parts of calcium lignosulfonate, 20 parts of synthetic hydrous silicon oxide fine powder and the balance diatomaceous earth, and the mixture is well mixed by stirring to obtain 100 parts of wettable powder.

### Formulation Example 10

### Wettable Powder

Fifteen parts of clothianidin and 15 parts of fluensulfone are added to a mixture of 4 parts of sodium lauryl sulfate, 2 parts of calcium lignosulfonate, 20 parts of synthetic hydrous silicon oxide fine powder and the balance diatomaceous earth, and the mixture is well mixed by stirring to obtain 100 parts of wettable powder.

### Formulation Examples 11 to 13

### Wettable Powder

The same procedures are carried out as in Formulation Examples 8 to 10, except for applying each compound and use amount listed in the following Table 2, in place of 15 parts of clothianidin, to obtain 100 parts of wettable powder.

TABLE 2

| Formulation | | Use amount |
|---|---|---|
| Example | Compound | [parts] |
| 11 | Thiamethoxam | 15 |
| 12 | Imidacloprid | 20 |
| 13 | Fipronil | 15 |

Next, the effect of the present invention will be shown by test examples.

The 2.0% fluensulfone granule used in the following test examples was prepared by the following method. The 2.0% fluensulfone granule was used in the test on the day prepared.

A 6 ml volume glass screw tube bottle (manufactured by Maruemu Corporation) was put with 50.5 mg of fluensulfone (purity of 99.0%) and 100 mg of aromatic hydrocarbon (product name: Solvesso 150ND, mainly containing C10-11 alkyl benzene as aromatic hydrocarbon, CAS No. 64742-94-5, manufactured by ExxonMobil Chemical Company), and covered and placed inside an ultrasonic bath to obtain a mixed liquid of fluensulfone and Solvesso 150ND.

Next, a 6 ml volume glass screw tube bottle (manufactured by Maruemu Corporation) was put with 2.3495 g of a ceramic porous body (product name: APLS N, containing silica (CAS No. 7631-86-9), aluminum oxide (CAS No. 1344-28-1) and iron oxide (CAS No. 1309-37-1) as components, manufactured by Isolite Insulating Products Co., Ltd.), and 150.5 mg of the above mixed liquid was added thereto in two parts at ambient temperature, and impregnated by covering with a lid and sufficiently mixing to obtain 2.5 g of a granule containing 2.0% of fluensulfone (hereinafter described as 2.0% fluensulfone granule).

### Test Example 1

A 0.5% clothianidin granule (product name: Dantotsu granule, manufactured by Sumitomo Chemical Co., Ltd.), a 0.5% thiamethoxam granule (product name: ACTARA granule 5, manufactured by Syngenta Japan K.K.), a 1.0% imidacloprid granule (product name: Admire 1 granule, manufactured by Bayer CropScience Limited) and a 2.0% fluensulfone granule were mixed using the amounts shown in Table 3 below to obtain each of test formulations (mixed granules). Mixing was performed in a 20 ml volume glass screw tube bottle (manufactured by Maruemu Corporation).

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 3 was uniformly placed (the treatment amount of each active ingredient per 10 a was as described in Table 4) on the surface of the cultivation soil in each cup, and sufficiently incorporated with the cultivation soil (the depth of incorporated soil was about 7 cm). Immediately, a hole with a depth of about 5 cm and a diameter of about 6 cm was made in the center of cultivation soil in the cup, and a cucumber nursery plant (nursery plant of 1.5 true-leaf stage raised in a 3 ounce cup) was planted in the hole, then the cup was placed in a room (25° C.). Seven days after planting (test formulation treatment), about 20 of second to third instar larvae of Aphis gossypii were released, and the above-ground part was fully covered with a plastic cup for preventing the tested insects from escaping. This is called as a treated section.

On the other hand, a cucumber nursery plant was planted in the hole, then the cup was placed in a room in the same way as in the treated section, except for not treating an compound, and seven days after planting, about 20 of second to third instar larvae of Aphis gossypii were released, and the above-ground part was fully covered with a plastic cup. This is called as a non-treated section.

Five days after release, life or death of the tested insects was observed. Based on the observation result, the control value was calculated according to the following equation 1). The control value is shown in Table 4. For each treatment, there were 2 replicates.

Control value (%)=100×(1−number of surviving insects in treated section on observation/number of surviving insects in non-treated section on observation) Equation 1);

TABLE 3

| | 0.5% | 0.5% | 1.0% | 2.0% | |
|---|---|---|---|---|---|
| | Clothianidin | Thiamethoxam | Imidacloprid | Fluensulfone | |
| | granule | granule | granule | granule | |
| Test formu- | 60 mg | | | 7.5 | mg |
| lation 1-1 | | | | | |
| Test formu- | 60 mg | | | 450 | mg |
| lation 1-2 | | | | | |
| Test formu- | | 60 mg | | 7.5 | mg |
| lation 2-1 | | | | | |
| Test formu- | | 60 mg | | 450 | mg |
| lation 2-2 | | | | | |
| Test formu- | | | 60 mg | 15 | mg |
| lation 3-1 | | | | | |
| Test formu- | | | 60 mg | 450 | mg |
| lation 3-2 | | | | | |

TABLE 4

| | Treatment amount as | |
|---|---|---|
| | active ingredient | Control |
| Tested compound | [/10a] | value |
| Test formu- | Clothianidin 30 g | 100 |
| lation 1-1 | Fluensulfone 15 g | |
| Test formu- | Clothianidin 30 g | 100 |
| lation 1-2 | Fluensulfone 900 g | |
| Test formu- | Thiamethoxam 30 g | 100 |
| lation 2-1 | Fluensulfone 15 g | |
| Test formu- | Thiamethoxam 30 g | 100 |
| lation 2-2 | Fluensulfone 900 g | |
| Test formu- | Imidacloprid 60 g | 100 |
| lation 3-1 | Fluensulfone 30 g | |
| Test formu- | Imidacloprid 60 g | 100 |
| lation 3-2 | Fluensulfone 900 g | |

### Test Example 2

A 860 ml volume plastic cup (the surface area of the top of the cup was about 1/10000 a) was filled with 700 g of soil, and 150 g of water was added and sufficiently incorporated thereto to prepare cultivation soil. Test formulations listed in Table 3 were uniformly placed (the treatment amount of each active ingredient per 10 a was as described in Table 5) on the surface of the cultivation soil in each cup, and sufficiently incorporated with the cultivation soil (the depth of incorporated soil was about 7 cm). Ten days after treating the test formulation, a hole with a depth of about 5 cm and a diameter of about 6 cm was made in the center of cultivation soil in the cup, and a cucumber nursery plant (nursery plant of 1.5 true-leaf stage raised in a 3 ounce cup) was planted in the hole, then the cup was placed in a room (25° C.). Seven days after planting, about 20 of second to third instar larvae of Aphis gossypii were released, and the above-ground part was fully covered with a plastic cup for preventing the tested insects from escaping. This is called as a treated section.

On the other hand, a cucumber nursery plant was planted in the hole, then the cup was placed in a room in the same way as in the treated section, except for not treating an compound, and seven days after planting, about 20 of second to third instar larvae of Aphis gossypii were released, and the above-ground part was fully covered with a plastic cup. This is called as a non-treated section.

Five days after release, life or death of the tested insects was observed. Based on the observation result, the control value was calculated according to the equation 1) described above. The control value is shown in Table 5. For each treatment, there were 2 replicates.

TABLE 5

| | Treatment amount as | |
|---|---|---|
| | active ingredient | Control |
| Tested compound | [/10a] | value |
| Test formu- | Clothianidin 30 g | 100 |
| lation 1-1 | Fluensulfone 15 g | |
| Test formu- | Clothianidin 30 g | 100 |
| lation 1-2 | Fluensulfone 900 g | |
| Test formu- | Thiamethoxam 30 g | 100 |
| lation 2-1 | Fluensulfone 15 g | |
| Test formu- | Thiamethoxam 30 g | 100 |
| lation 2-2 | Fluensulfone 900 g | |
| Test formu- | Imidacloprid 60 g | 100 |
| lation 3-1 | Fluensulfone 30 g | |
| Test formu- | Imidacloprid 60 g | 100 |
| lation 3-2 | Fluensulfone 900 g | |

### Test Example 3

A 0.5% thiamethoxam granule (product name: ACTARA granule 5, manufactured by Syngenta Japan K.K.) and a 2.0% fluensulfone granule were mixed using the amounts shown in Table 6 below to obtain each of test formulations (mixed granules). Mixing was performed in a 20 ml volume glass screw tube bottle (manufactured by Maruemu Corporation).

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 6, 120 mg of a 0.5% thiamethoxam granule, and a 15 mg of 2.0% fluensulfone granule or 600 mg of a 2.0% fluensulfone granule were each uniformly placed (the treatment amount of each active ingredient per 10 a was as described in Table 7) on the surface of the cultivation soil in each cup, and sufficiently incorporated with the cultivation soil (the depth of incorporated soil was about 7 cm). Immediately, a furrow with a depth of about 5 cm was cut along the centerline (diameter) of cultivation soil in the cup, and a sweet potato vine cutting was planted in the furrow, then the cup was placed in a room (25° C.). Eight days after planting (treatment of test formulation), 10 of second instar larvae of Spodoptera litura were released, and the above-ground part was fully covered with a plastic cup for preventing the tested insects from escaping. This is called as a treated section A.

In the same way as in the treated section A, each of test formulations listed in Table 6 was uniformly placed (the treatment amount of each active ingredient per 10 a was as described in Table 7) on the surface of the cultivation soil in each cup, and sufficiently incorporated with the cultivation soil. Immediately, the surface of cultivation soil was covered with polyethylene black mulch (manufactured by SEKISUI FILM CO., LTD.), a furrow with a depth of about 5 cm was cut (the black mulch was notched so that a furrow was easily cut) along the centerline (diameter) of cultivation soil in the cup, and a sweet potato vine cutting was planted in the furrow, then the cup was placed in a room (25° C.). Eight days after planting (treatment of test formulation), 10 of second instar larvae of Spodoptera litura were released, and the above-ground part was fully covered with a plastic cup. This is called as a treated section B.

In the same way as in the treated section A, except for not treating an compound, a sweet potato vine cutting was planted in cultivation soil in each cup, then immediately, each of test formulations listed in Table 6, 120 mg of a 0.5% thiamethoxam granule, and 15 mg of a 2.0% fluensulfone granule or 600 mg of a 2.0% fluensulfone granule were each uniformly placed (the treatment amount of each active ingredient per 10 a was as described in Table 7) on the surface of the cultivation soil in each cup, and the cup was placed in a room (25° C.). Eight days after planting (treatment of test formulation), 10 of second instar larvae of Spodoptera litura were released, and the above-ground part was fully covered with a plastic cup. This is called as a treated section C. The treatment form of treated section C is soil surface treatment.

On the other hand, a sweet potato vine cutting was planted in cultivation soil, and the cup was placed in a room in the same way as in the treated section A, except for not treating any compound. Eight days after planting, 10 of second instar larvae of Spodoptera litura were released, and the above-ground part was fully covered with a plastic cup. This is called as a non-treated section.

Five days after release, life or death of the tested insects was observed. Based on the observation result, the mortality and the corrected mortality were calculated according to the following equation 2) and the following equation 3), respectively. The corrected mortality is shown in Table 7. For each treatment, there were 2 replicates.

Mortality (%)={(number of tested insects−number of surviving insects)/number of tested insects}×100 Equation 2);

Corrected mortality (%)={(mortality in treated section A, treated section B or treated section C−mortality in non-treated section)/(100−mortality in non-treated section)}×100 Equation 3);

TABLE 6

| | 0.5% Thiamethoxam | 2.0% Fluensulfone |
|---|---|---|
| | granule | granule |
| Test formu- | 120 mg | 15 mg |
| lation | | |
| Test formu- | 120 mg | 600 mg |
| lation 4-2 | | |

TABLE 7

| | | Treatment amount as | | Corrected |
|---|---|---|---|---|
| Treated | | active ingredient | | mortality |
| section | Tested compound | [/10a] | | [%] |
| A | 0.5% Thiamethoxam | Thiamethoxam | 60 g | 44 |
| | granule | | | |
| | 2.0% Fluensulfone | Fluensulfone | 30 g | 0 |
| | granule | | | |
| | 2.0% Fluensulfone | Fluensulfone | 1200 g | 19 |
| | granule | | | |
| | Test formulation 4-1 | Thiamethoxam | 60 g | 88 |
| | | Fluensulfone | 30 g | |
| | Test formulation 4-2 | Thiamethoxam | 60 g | 88 |
| | | Fluensulfone | 1200 g | |
| B | Test formulation 4-2 | Thiamethoxam | 60 g | 94 |
| | | Fluensulfone | 1200 g | |
| C | 0.5% Thiamethoxam | Thiamethoxam | 60 g | 25 |
| | granule | | | |
| | 2.0% Fluensulfone | Fluensulfone | 30 g | 0 |
| | granule | | | |
| | 2.0% Fluensulfone | Fluensulfone | 1200 g | 19 |
| | granule | | | |
| | Test formulation 4-1 | Thiamethoxam | 60 g | 19 |
| | | Fluensulfone | 30 g | |
| | Test formulation 4-2 | Thiamethoxam | 60 g | 31 |
| | | Fluensulfone | 1200 g | |

### Test Example 4

A 1.0% fipronil granule (product name: Prince granule, manufactured by BASF Japan) and a 0.8% oxamyl granule (product name: VYDATE L granule, manufactured by MITSUI CHEMICALS AGRO, INC) were mixed using the amounts shown in Table 8 below to obtain each of test formulations (mixed granules). Mixing was performed in a 20 ml volume glass screw tube bottle (manufactured by Maruemu Corporation).

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 8 was uniformly placed (the treatment amount of each active ingredient per 10 a was as described in Table 9) on the surface of the cultivation soil in each cup, and sufficiently incorporated with the cultivation soil (the depth of incorporated soil was about 7 cm). Immediately, a hole with a depth of about 5 cm and a diameter of about 6 cm was made in the center of cultivation soil in the cup, and a cucumber nursery plant (nursery plant of 1.5 true-leaf stage raised in a 3 ounce cup) was planted in the hole, then the cup was placed in a room (25° C.). Seven days after planting (test formulation treatment), about 20 of second to third instar larvae of Aphis gossypii were released, and the above-ground part was fully covered with a plastic cup for preventing the tested insects from escaping. This is called as a treated section A.

In the same way as in the treated section A, test formulation listed in Table 8 was uniformly placed (the treatment amount of each active ingredient per 10 a was as described in Table 9) on the surface of the cultivation soil in each cup, and sufficiently incorporated with the cultivation soil. Immediately, the surface of cultivation soil was covered with polyethylene black mulch (manufactured by SEKISUI FILM CO., LTD.), and a hole with a depth of about 5 cm and a diameter of about 6 cm was made in the center of cultivation soil in the cup. A cucumber nursery plant (nursery plant of 1.5 true-leaf stage raised in a 3 ounce cup) was planted in the hole, and the cup was placed in a room (25° C.). Seven days after planting (test formulation treatment), about 20 of second to third instar larvae of Aphis gossypii were released, and the above-ground part was fully covered with a plastic cup. This is called as a treated section B.

On the other hand, a cucumber nursery plant was planted in the hole, then, the cup was placed in a room in the same way as in the treated section A, except for not treating an compound, and seven days after planting, about 20 of second to third instar larvae of Aphis gossypii were released, and the above-ground part was fully covered with a plastic cup. This is called as a non-treated section.

Five days after release, life or death of the tested insects was observed. Based on the observation result, the control value was calculated according to the following equation 4). The control value is shown in Table 9. For each treatment, there were 2 replicates.

Control value (%)=100×(1−number of surviving insects in treated section A or treated section B on observation/number of surviving insects in non-treated section on observation) Equation 4)

TABLE 8

| | 1.0% Fipronil granule | 0.8% Oxamyl granule |
|---|---|---|
| Test formulation 5-1 | 120 mg | 75 mg |
| Test formulation 5-2 | 120 mg | 1500 mg |

TABLE 9

| | | Treatment amount as | | | |
|---|---|---|---|---|---|
| Treated | | active ingredient | | | Control |
| section | Tested compound | [/10a] | | | value |
| A | Test formulation 5-1 | Fipronil | 120 | g | 98 |
| | | Oxamyl | 60 | g | |
| | Test formulation 5-2 | Fipronil | 120 | g | 100 |
| | | Oxamyl | 1200 | g | |
| B | Test formulation 5-1 | Fipronil | 120 | g | 100 |
| | | Oxamyl | 60 | g | |
| | Test formulation 5-2 | Fipronil | 120 | g | 100 |
| | | Oxamyl | 1200 | g | |

### Test Example 5

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 8 was uniformly placed (the treatment amount of each active ingredient per 10 a was as described in Table 10) on the surface of the cultivation soil in each cup, and sufficiently incorporated with the cultivation soil (the depth of incorporated soil was about 7 cm). Ten days after treating the test formulation, a hole with a depth of about 5 cm and a diameter of about 6 cm was made in the center of cultivation soil in the cup, and a cucumber nursery plant (nursery plant of 1.5 true-leaf stage raised in a 3 ounce cup) was planted in the hole, then the cup was placed in a room (25° C.). Seven days after planting, about 20 of second to third instar larvae of Aphis gossypii were released, and the above-ground part was fully covered with a plastic cup for preventing the tested insects from escaping. This is called as a treated section.

On the other hand, a cucumber nursery plant was planted in the hole, then the cup was placed in a room in the same way as in the treated section, except for not treating an compound, and seven days after planting, about 20 of second to third instar larvae of Aphis gossypii were released, and the above-ground part was fully covered with a plastic cup. This is called as a non-treated section.

Five days after release, life or death of the tested insects was observed. Based on the observation result, the control value was calculated according to the equation 1) described above. The control value is shown in Table 10. For each treatment, there were 2 replicates.

TABLE 10

| | Treatment amount as | | |
|---|---|---|---|
| | active ingredient | | |
| Tested compound | [/10a] | | Control value |
| Test formulation 5-1 | Fipronil | 120 g | 96 |
| | Oxamyl | 60 g | |
| Test formulation 5-2 | Fipronil | 120 g | 98 |
| | Oxamyl | 1200 g | |

### Test Example 6

A 1.0% fipronil granule (product name: Prince granule, manufactured by BASF Japan) and a 3.0% cadusafos granule (product name: Rugby MC granule, manufactured by ISK BIOSCIENCES K.K) were mixed using the amounts shown in Table 11 below to obtain each of test formulations (mixed granules). Mixing was performed in a 20 ml volume glass screw tube bottle (manufactured by Maruemu Corporation).

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 11 was uniformly placed (the treatment amount of each active ingredient per 10 a was as described in Table 12) on the surface of the cultivation soil in each cup, and sufficiently incorporated with the cultivation soil (the depth of incorporated soil was about 7 cm). Immediately, a hole with a depth of about 6 cm and a diameter of about 4 cm was made in the center of cultivation soil in the cup, and a cabbage nursery plant (nursery plant of 2.5 true-leaf stage raised in a 128-hole cell tray) was planted in the hole, then the cup was placed in a room (25° C.). Five days after planting (test formulation treatment), 10 of second instar larvae of Plutella xylostella were released, and the above-ground part was fully covered with a plastic cup for preventing the tested insects from escaping. This is called as a treated section.

On the other hand, a cabbage nursery plant was planted, then, the cup was placed in a room in the same way as in the treated section, except for not treating an compound, and five days after planting, 10 of second instar larvae of Plutella xylostella were released, and the above-ground part was fully covered with a plastic cup. This is called as a non-treated section.

Five days after release, life or death of the tested insects was observed. Based on the observation result, the mortality and the corrected mortality were calculated according to the following equation 5) and the following equation 6), respectively. The corrected mortality is shown in Table 12. For each treatment, there were 2 replicates.

Mortality (%)={(number of tested insects−number of surviving insects)/number of tested insects}×100 Equation 5);

Corrected mortality (%)={(mortality in treated section−mortality in non-treated section)/(100−mortality in non-treated section)}×100 Equation 6);

TABLE 11

| | | 3.0% Cadusafos |
|---|---|---|
| | 1.0% Fipronil granule | granule |
| Test formulation 6-1 | 120 mg | 20 mg |
| Test formulation 6-2 | 30 mg | 300 mg |

TABLE 12

| | Treatment amount as | | |
|---|---|---|---|
| | active ingredient | | Corrected mortality |
| Tested compound | [/10a] | | [%] |
| Test formulation 6-1 | Fipronil | 120 g | 100 |
| | Cadusafos | 60 g | |
| Test formulation 6-2 | Fipronil | 30 g | 100 |
| | Cadusafos | 900 g | |

### Test Example 7

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 11 was uniformly placed (the treatment amount of each active ingredient per 10 a was as described in Table 13) on the surface of the cultivation soil in each cup, and sufficiently incorporated with the cultivation soil (the depth of incorporated soil was about 7 cm). Ten days after test formulation treatment, a hole with a depth of about 6 cm and a diameter of about 4 cm was made in the center of cultivation soil in the cup, and a cabbage nursery plant (nursery plant of 2.5 true-leaf stage raised in a 128-hole cell tray) was planted, then the cup was placed in a room (25° C.). Five days after planting, 10 of second instar larvae of Plutella xylostella were released, and the above-ground part was fully covered with a plastic cup for preventing the tested insects from escaping. This is called as a treated section.

On the other hand, a cabbage nursery plant was planted, then, the cup was placed in a room in the same way as in the treated section, except for not treating an compound, and five days after planting, 10 of second instar larvae of Plutella xylostella were released, and the above-ground part was fully covered with a plastic cup. This is called as a non-treated section.

Five days after release, life or death of the tested insects was observed. Based on the observation result, the mortality and the corrected mortality were calculated according to the equation 5) and the equation 6), respectively. The corrected mortality is shown in Table 13. For each treatment, there were 2 replicates.

TABLE 13

| | Treatment amount as | | |
|---|---|---|---|
| | active ingredient | | Corrected mortality |
| Tested compound | [/10a] | | [%] |
| Test formulation 6-1 | Fipronil | 120 g | 93 |
| | Cadusafos | 60 g | |
| Test formulation 6-2 | Fipronil | 30 g | 100 |
| | Cadusafos | 900 g | |

### Test Example 8

A 0.5% thiamethoxam granule (product name: ACTARA granule 5, manufactured by Syngenta Japan K.K.) and a 0.8% oxamyl granule (product name: VYDATE L granule, manufactured by MITSUI CHEMICALS AGRO, INC) were mixed using the amounts shown in Table 14 below to obtain each of test formulations (mixed granules). Mixing was performed in a 20 ml volume glass screw tube bottle (manufactured by Maruemu Corporation).

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 14 was uniformly placed (the treatment amount of each active ingredient per 10 a was as described in Table 15) on the surface of the cultivation soil in each cup, and sufficiently incorporated with the cultivation soil (the depth of incorporated soil was about 7 cm. Immediately, a furrow with a depth of about 5 cm was cut along the centerline (diameter) of cultivation soil in the cup, and a sweet potato vine cutting was planted in the furrow, then the cup was placed in a room (25° C.). Four days after planting (test formulation treatment), 10 of first instar larvae of Spodoptera litura were released, and the above-ground part was fully covered with a plastic cup for preventing the tested insects from escaping. This is called as a treated section A.

In the same way as in the treated section A, test formulation listed in Table 14 was uniformly placed (the treatment amount of each active ingredient per 10 a was as described in Table 15) on the surface of the cultivation soil in each cup, and sufficiently incorporated with the cultivation soil. Immediately, the surface of cultivation soil was covered with polyethylene black mulch (manufactured by SEKISUI FILM CO., LTD.), a furrow with a depth of about 5 cm was cut (the black mulch was notched so that a furrow was easily cut) along the centerline (diameter) of cultivation soil in the cup, and a sweet potato vine cutting was planted in the furrow, then the cup was placed in a room (25° C.). Four days after planting (test formulation treatment), 10 of first instar larvae of Spodoptera litura were released, and the above-ground part was fully covered with a plastic cup. This is called as a treated section B.

On the other hand, a sweet potato vine cutting was planted in the furrow, and the cup was placed in a room in the same way as in the treated section A, except for not treating an compound. Four days after planting, 10 of first instar larvae of Spodoptera litura were released, and the above-ground part was fully covered with a plastic cup. This is called as a non-treated section.

Five days after release, life or death of the tested insects was observed. Based on the observation result, the mortality and the corrected mortality were calculated according to the equation 2) and the equation 3), respectively. The corrected mortality is shown in Table 15. For each treatment, there were 2 replicates.

TABLE 14

| | 0.5% Thiamethoxam | |
|---|---|---|
| | granule | 0.8% Oxamyl granule |
| Test formulation 7-1 | 120 mg | 37.5 mg |
| Test formulation 7-2 | 120 mg | 1125 mg |

TABLE 15

| | | Treatment amount as | | Corrected |
|---|---|---|---|---|
| Treated | | active ingredient | | mortality |
| section | Tested compound | [/10a] | | [%] |
| A | Test formulation 7-1 | Thiamethoxam | 60 g | 100 |
| | | Oxamyl | 30 g | |
| | Test formulation 7-2 | Thiamethoxam | 60 g | 100 |
| | | Oxamyl | 900 g | |
| B | Test formulation 7-1 | Thiamethoxam | 60 g | 100 |
| | | Oxamyl | 30 g | |
| | Test formulation 7-2 | Thiamethoxam | 60 g | 100 |
| | | Oxamyl | 900 g | |

### Test Example 9

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 14 was uniformly placed (the treatment amount of each active ingredient per 10 a was as described in Table 16) on the surface of the cultivation soil in each cup, and sufficiently incorporated with the cultivation soil (the depth of incorporated soil was about 7 cm). Ten days after test formulation treatment, a furrow with a depth of about 5 cm was cut along the centerline (diameter) of cultivation soil in the cup, and a sweet potato vine cutting was planted in the furrow, then the cup was placed in a room (25° C.). Four days after planting, 10 of first instar larvae of Spodoptera litura were released, and the above-ground part was fully covered with a plastic cup for preventing the tested insects from escaping. This is called as a treated section.

On the other hand, a sweet potato vine cutting was planted in the furrow, and the cup was placed in a room in the same way as in the treated section, except for not treating an compound. Four days after planting, 10 of first instar larvae of Spodoptera litura were released, and the above-ground part was fully covered with a plastic cup. This is called as a non-treated section.

Five days after release, life or death of the tested insects was observed. Based on the observation result, the mortality and the corrected mortality were calculated according to the equation 5) and the equation 6), respectively. The corrected mortality is shown in Table 16. For each treatment, there were 2 replicates.

TABLE 16

| | Treatment amount as | | |
|---|---|---|---|
| | active ingredient | | Corrected mortality |
| Tested compound | [/10a] | | [%] |
| Test formulation 7-1 | Thiamethoxam | 60 g | 100 |
| | Oxamyl | 30 g | |
| Test formulation 7-2 | Thiamethoxam | 60 g | 100 |
| | Oxamyl | 900 g | |

### Test Example 10

A 860 ml volume plastic cup (the surface area of the top of the cup was about 1/10000 a) was filled with 700 g of soil, and 150 g of water was added and sufficiently incorporated thereto to prepare cultivation soil. Test formulations listed in Table 6, Table 8 and Table 14 were uniformly placed (the treatment amount of each active ingredient per 10 a was as described in Table 17) on the surface of the cultivation soil in each cup, and sufficiently incorporated with the cultivation soil (the depth of incorporated soil was about 7 cm). Immediately, a hole with a depth of about 5 cm and a diameter of about 4 cm was made in the center of cultivation soil in the cup, and a potato tuber was planted in the hole, then the cup was placed in a room (25° C.). Fourteen days after planting (test formulation treatment), about 20 of second to third instar larvae of Aphis gossypii were released, and the above-ground part was fully covered with a plastic cup for preventing the tested insects from escaping. This is called as a treated section.

On the other hand, a potato tuber was planted in the hole, then, the cup was placed in a room in the same way as in the treated section, except for not treating an compound, and fourteen days after planting, about 20 of second to third instar larvae of Aphis gossypii were released, and the above-ground part was fully covered with a plastic cup. This is called as a non-treated section.

Five days after release, life or death of the tested insects was observed. Based on the observation result, the control value was calculated according to the equation 1). The control value is shown in Table 17. For each treatment, there were 2 replicates.

TABLE 17

| | Treatment amount as | | |
|---|---|---|---|
| | active ingredient | | |
| Tested compound | [/10a] | | Control value |
| Test formulation 4-1 | Thiamethoxam | 60 g | 100 |
| | Fluensulfone | 30 g | |
| Test formulation 4-2 | Thiamethoxam | 60 g | 100 |
| | Fluensulfone | 1200 g | |
| Test formulation 5-1 | Fipronil | 120 g | 100 |
| | Oxamyl | 60 g | |
| Test formulation 5-2 | Fipronil | 120 g | 100 |
| | Oxamyl | 1200 g | |
| Test formulation 7-1 | Thiamethoxam | 60 g | 100 |
| | Oxamyl | 30 g | |
| Test formulation 7-2 | Thiamethoxam | 60 g | 100 |
| | Oxamyl | 900 g | |

### Test Example 11

A 0.5% clothianidin granule (product name: Dantotsu granule, manufactured by Sumitomo Chemical Co., Ltd.), a 2.0% fluensulfone granule and a 0.8% oxamyl granule (product name: VYDATE L granule, manufactured by MITSUI CHEMICALS AGRO, INC) were mixed using the amounts shown in Table 18 below to obtain each of test formulations (mixed granules). Mixing was performed in a 20 ml volume glass screw tube bottle (manufactured by Maruemu Corporation).

A 860 ml volume plastic cup (the surface area of the top of the cup was about 1/10000 a) was filled with 700 g of soil, and 150 g of water was added and sufficiently incorporated thereto to prepare cultivation soil. Test formulation listed in Table 18, 120 mg of a 0.5% Clothianidin granule, 15 mg of a 2.0% fluensulfone granule or 600 mg of a 2.0% fluensulfone granule, and 750 mg of a 0.8% oxamyl granule were each uniformly placed (the treatment amount of each active ingredient per 10 a was as described in Table 19) on the surface of the cultivation soil in each cup, and sufficiently incorporated with the cultivation soil (the depth of incorporated soil was about 7 cm). Immediately, a furrow with a depth of about 5 cm was cut along the centerline (diameter) of cultivation soil in the cup, and a sweet potato vine cutting was planted in the furrow, then the cup was placed in a room (25° C.). Seven days after planting (treatment of test formulation), 10 of second instar larvae of Spodoptera litura were released, and the above-ground part was fully covered with a plastic cup for preventing the tested insects from escaping. This is called as a treated section.

On the other hand, a sweet potato vine cutting was planted in the furrow, and the cup was placed in a room in the same way as in the treated section, except for not treating an compound. Seven days after planting, 10 of second instar larvae of Spodoptera litura were released, and the above-ground part was fully covered with a plastic cup. This is called as a non-treated section.

Five days after release, life or death of the tested insects was observed. Based on the observation result, the mortality and the corrected mortality were calculated according to the equation 5) and the equation 6), respectively. The corrected mortality is shown in Table 19. For each treatment, there were 2 replicates.

TABLE 18

| | 0.5% | 2.0% | |
|---|---|---|---|
| | Clothianidin | Fluensulfone | 0.8% Oxamyl |
| | granule | granule | granule |
| Test formulation 8-1 | 120 mg | 15 mg | |
| Test formulation 8-2 | 120 mg | 600 mg | |
| Test formulation 9 | 120 mg | | 750 mg |

TABLE 19

| | Treatment amount as | | |
|---|---|---|---|
| | active ingredient | | Corrected mortality |
| Tested compound | [/10a] | | [%] |
| 0.5% Clothianidin | Clothianidin | 60 g | 38 |
| granule | | | |
| 2.0% Fluensulfone | Fluensulfone | 30 g | 6 |
| granule | | | |
| 2.0% Fluensulfone | Fluensulfone | 1200 g | 6 |
| granule | | | |
| 0.8% Oxamyl granule | Oxamyl | 600 g | 19 |
| Test formulation 8-1 | Clothianidin | 60 g | 88 |
| | Fluensulfone | 30 g | |
| Test formulation 8-2 | Clothianidin | 60 g | 88 |
| | Fluensulfone | 1200 g | |
| Test formulation 9 | Clothianidin | 60 g | 88 |
| | Oxamyl | 600 g | |

### Test Example 12

A 1.0% fipronil granule (product name: Prince granule, manufactured by BASF Japan) and a 2.0% fluensulfone granule are mixed using the amounts shown in Table 20 below to obtain each of test formulations (mixed granules). Mixing is performed in a 20 ml volume glass screw tube bottle (manufactured by Maruemu Corporation).

A 860 ml volume plastic cup (the surface area of the top of the cup is about 1/10000 a) is filled with 700 g of soil, and 150 g of water is added and sufficiently incorporated thereto to prepare cultivation soil. Test formulation listed in Table 20 is uniformly placed (the treatment amount of each active ingredient per 10 a is as described in Table 21) on the surface of the cultivation soil in each cup, and sufficiently incorporated with the cultivation soil (the depth of incorporated soil is about 7 cm). Immediately, a hole with a depth of about 6 cm and a diameter of about 6 cm is made in the center of cultivation soil in the cup, and a cabbage nursery plant (nursery plant of 1.5 true-leaf stage raised in a 3 ounce cup) is planted in the hole, then the cup is placed in a room (25° C.). Three days after planting (test formulation treatment), 20 eggs of Hellula undalis are inoculated, and the above-ground part is fully covered with a plastic cup for preventing the tested insects from escaping. This is called as a treated section.

On the other hand, a cabbage nursery plant is planted in the hole, then the cup is placed in a room in the same way as in the treated section, except for not treating an compound, and three days after planting, 20 eggs of Hellula undalis are inoculated, and the above-ground part is fully covered with a plastic cup. This is called as a non-treated section.

Seven days after release, life or death of the hatched insects is observed. Based on the observation result, the mortality and the corrected mortality are calculated according to the following equation 7) and the following equation 8), respectively. For each treatment, there were 2 replicates.

Mortality (%)={(number of tested eggs−number of surviving eggs)/number of tested insects}×100 Equation 7);

Corrected mortality (%)={(mortality in treated section−mortality in non-treated section)/(100−mortality in non-treated section)}×100 Equation 8);

TABLE 20

| | 1.0% Fipronil | 2.0% Fluensulfone |
|---|---|---|
| | granule | granule |
| Test formulation 10-1 | 180 mg | 45 mg |
| Test formulation 10-2 | 180 mg | 630 mg |

TABLE 21

| | |
|---|---|
| | Treatment amount as active ingredient |
| Tested compound | [/10a] |

| | | |
|---|---|---|
| Test formulation 10-1 | Fipronil | 180 g |
| | Fluensulfone | 90 g |
| Test formulation 10-2 | Fipronil | 180 g |
| | Fluensulfone | 1260 g |

### INDUSTRIAL APPLICABILITY

According to the present invention, a control effect on pests is improved.

1. A method for controlling pests comprising a step of incorporating into the soil effective amounts of one or more kinds of compounds selected from the following compound group (A) and one or more kinds of compounds selected from the following compound group (B).
Compound group (A): group consisting of clothianidin, thiamethoxam, imidacloprid, and fipronil.
Compound group (B): group consisting of cadusafos, oxamyl, and fluensulfone.

2. The method according to claim 1, wherein the weight ratio of the one or more kinds of compounds selected from the compound group (A) to the one or more kinds of compounds selected from the compound group (B) is in the range of 20:1 to 1:200.

3. The method according to claim 1, wherein the step is a step of incorporating into the soil a granule containing effective amounts of the one or more kinds of compounds selected from the compound group (A) and the one or more kinds of compounds selected from the compound group (B).

4. The method according to claim 1, comprising steps of incorporating into the soil effective amounts of the one or more kinds of compounds selected from the compound group (A) and the one or more kinds of compounds selected from the compound group (B), and planting a crop in the incorporated soil.

5. The method according to claim 4, wherein the step of planting a crop, within 20 days from immediately after incorporating into the soil effective amounts of the one or more kinds of compounds selected from the compound group (A) and the one or more kinds of compounds selected from the compound group (B).

6. The method according to claim 4, wherein the crop is sweet potato.
